(19) United States
(12) Patent Application Publication
(10) Pub. No.: US 2009/0142152 A1
(43) Pub. Date: Jun. 4, 2009

(54) Reinforcement drill

(76) Inventors: Chung-Liang Liao, Feng Yuan City (TW); Chung-Hung Liao, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,709

(22) Filed: Jan. 15, 2008

(30) Foreign Application Priority Data
Nov. 29, 2007 (TW) 096220514

(51) Int. Cl. B23B 51/00

(52) U.S. Cl. 408/225

(57) ABSTRACT

A drill includes a flute and a shank, a feed screw extends axially from an end of the flute. A plurality of first cutting edges extend radially from the flute and are arranged in spiral form. A plurality of second cutting edges are formed on respective tops of the first cutting edges and these second cutting edges are dull when compared with the first cutting edges. Each second cutting edge has a thick support portion connected at a root portion thereof.

### FIELD OF THE INVENTION

The present invention relates to a reinforcement drill with a thick support portion connected with the first cutting edges and the spurs are made to be dull so as to break hard material during drilling.

### BACKGROUND OF THE INVENTION

A conventional drill 30 is shown in FIG. 5 and generally includes a flute connected with a shank which can be clamped by a drilling machine which is not shown. A feed screw 32 extends axially from a front end of the drill 30 so as to position the drill 30 to the object to be drilled at the first stage of drilling. A plurality of cutting edges 31 are formed along the flute in a spiral pattern. Each cutting edge 31 forms a spur 33 at a top thereof and the spur 32 is thin and sharp to cut into the object. It is noted that the spurs 33 are easily broken when drilling a hard material such as nails in the object. The broken spurs 32 might be left in the object or crack the object.

The present invention intends to provide a reinforcement drill which includes first cutting edges in a spiral form along the flute of the drill and a slightly dull second cutting edges which extend at a large angle to the first cutting edges and each second cutting edge includes a thick support portion so that hard material can be easily cut by the second cutting edges.

### SUMMARY OF THE INVENTION

The present invention relates to a drill which comprises a flute and a shank connected to a first end of the flute, a feed screw extends axially from a second end of the flute. A plurality of first cutting edges extend radially from the flute and are arranged in spiral form. A plurality of second cutting edges are formed on respective tops of the first cutting edges and each second cutting edge has a support portion connected at a root portion thereof. The second cutting edges are slightly dull and have thick support portion so that hard material can easily be cut by the second cutting edges when drilling.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the drill of the present invention;

FIG. 2 shows that an angle θ is defined between a central axis of the flute and the first cutting edge is 30 degrees;

FIG. 3 is a top view of the drill of the present invention;

FIG. 4 shows the nail in the object is cut by the second cutting edges of the drill of the present invention, and

FIG. 5 shows a conventional drill.

### DETAILED DESCRIPTION OF THE PREFERRED EMBODIMENT

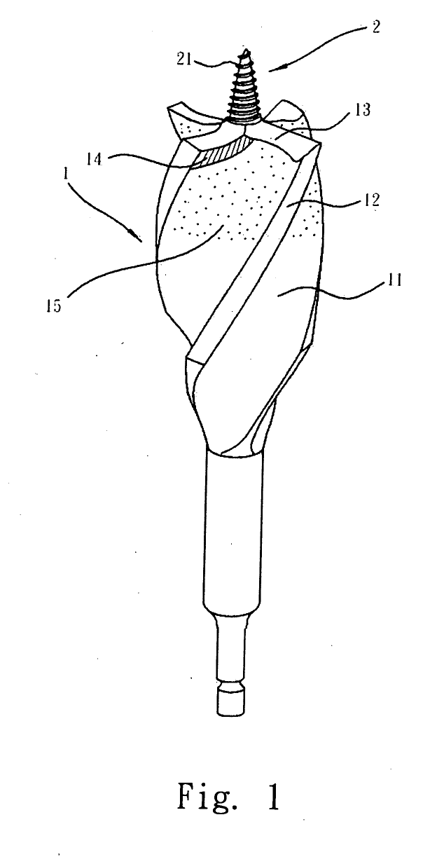

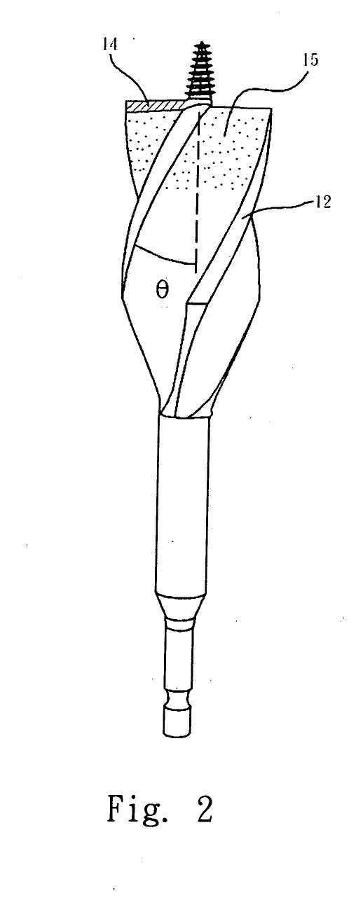

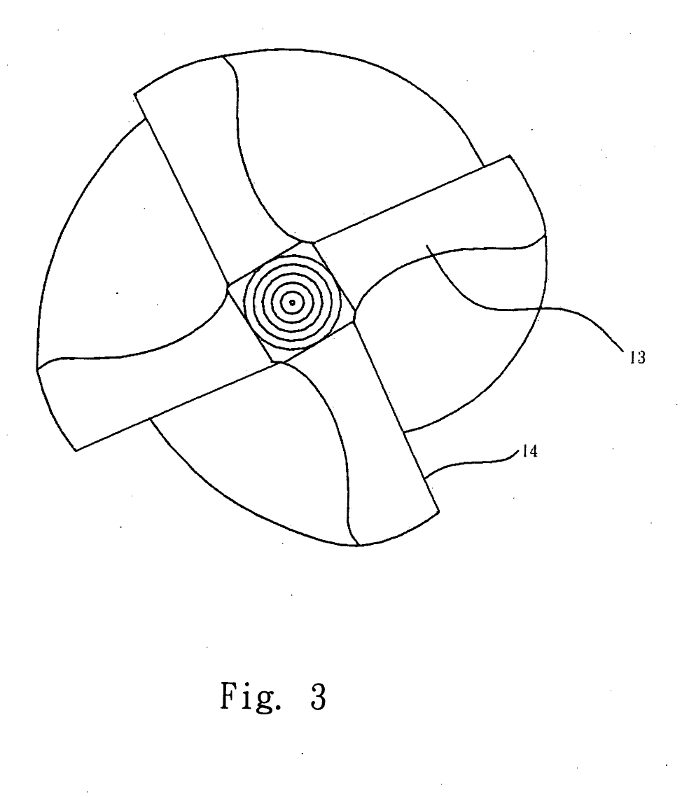

Referring to FIGS. 1 to 3, the drill 1 of the present invention comprises a flute and a shank which is connected to a first end of the flute 11 so as to be clamped on a drill machine (not shown). A feed screw 2 extends axially from a second end of the flute 11 and includes spiral teeth 21 defined in an outer periphery thereof. A plurality of first cutting edges 12 extend radially from the flute 11 and are arranged in spiral form. An angle θ is defined between a central axis of the flute 11 and the first cutting edge 12 is 30 degrees. A plurality of second cutting edges 13 are formed on respective tops of the first cutting edges 12 and dull when compared with the first cutting edges 12. Each second cutting edge 13 has a thick support portion 14 connected at a root portion thereof. A reinforcement section 15 made by harden material forms the second end of the flute 11. Parts of the first cutting edges 12, the second cutting edges 13 and the support portions 14 are formed on the second section 15.

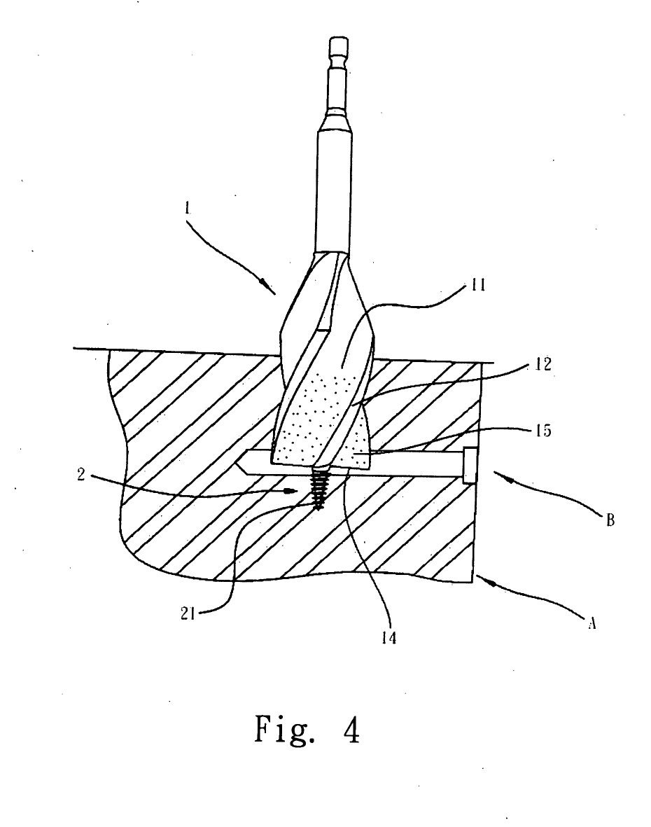

The angle θ defined between a central axis of the flute 11 and the first cutting edge 12 makes the drill 1 to be more efficient when drilling and the reinforcement section 15 makes the drill 1 to easily cut through hard material of object to be drilled. The slightly dull second cutting edges 13 can bear large stress so as when drilling through a wooden object “A” as shown in FIG. 4, the second cutting edges 13 can cut through nail “B” left in the object “A” without breaking the second cutting edges 13.

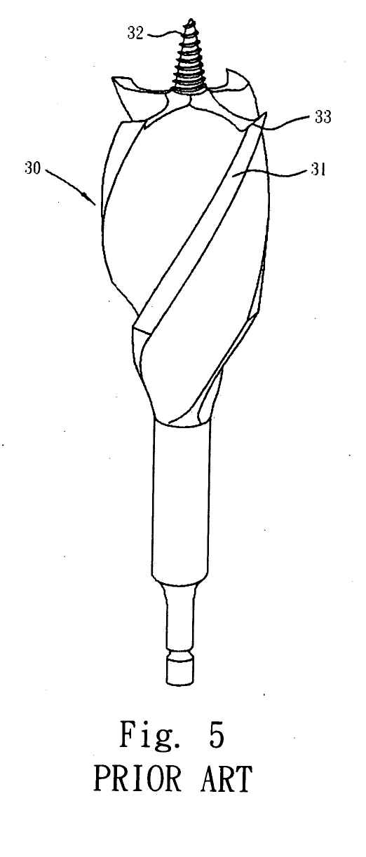

The second cutting edges 13 are defined by an inclined surface which is defined by an angle relative to the horizontal plane which is perpendicular to the axis of the drill 1, the angle is less than that of the conventional drill as shown in FIG. 5 so that the thickness of the second cutting edges 13 together with the support portions 14 are obviously thicker than the conventional drill.

While we have shown and described the embodiment in accordance with the present invention, it should be clear to those skilled in the art that further embodiments may be made without departing from the scope of the present invention.

What is claimed is:

1. A drill comprising:
a flute and a shank connected to a first end of the flute, a feed screw extending axially from a second end of the flute, a plurality of first cutting edges extending radially from the flute and arranged in spiral form, a plurality of second cutting edges formed on respective tops of the first cutting edges and each second cutting edge having a support portion connected at a root portion thereof.

2. The drill as claimed in claim 1, wherein the feed screw includes spiral teeth defined in an outer periphery thereof.

3. The drill as claimed in claim 1, wherein the flute includes a reinforcement section which is made by harden material and the reinforcement section forms the second end of the flute, parts of the first cutting edges, the second cutting edges and the support portions are formed on the second section.

4. The drill as claimed in claim 1, wherein an angle θ between a central axis of the flute and the first cutting edge is 30 degrees.
